(19) United States
(12) Patent Application Publication
(10) Pub. No.: US 2011/0281488 A1
(43) Pub. Date: Nov. 17, 2011

(54) ENERGY-HARVESTING ARTICLE

(76) Inventor: Mei-Ying LI, Kaohsiung (TW)

(21) Appl. No.: 12/777,985

(22) Filed: May 11, 2010

(51) Int. Cl. B32B 15/14

(52) U.S. Cl. 442/378

(57) ABSTRACT

An energy-harvesting article includes two textile units each having a thin metal sheet and a leather sheet, a first adhesive layer interconnecting the thin metal sheets of the textile units, and two second adhesive layers each interconnecting the thin metal sheet and the leather sheet of a respective textile unit. The leather sheet covers the thin metal sheet, and includes a non-woven fabric substrate and a leather coating layer. Each of the non-woven fabric substrate and the leather coating layer includes a catalytic composition. By wrapping the energy-harvesting article to pipes, the material of the energy-harvesting article is considered as self-assembled monolayers, and the energy-harvesting article is harvesting energy from the environment and resonant tunneling through inner portions of the pipes to activate flowing medium inside the pipes, thereby improving energy efficiency and achieving energy conservation and reduction of greenhouse gas emission.

### BACKGROUND OF THE INVENTION

1. Field of the Invention

This invention relates to an article with catalyst, more particularly to an article that can promote energy conservation and emission reduction.

2. Description of the Related Art

Currently, how to effectively put to use different energy resources is of everybody's concern. Taking for example a car with gasoline as its main fuel, the number of car users worldwide is increasing daily, so that the demand of gasoline also increases. The increasing global price of crude oil is such that oil prices have recently reached new record highs. With the current economic recession continuing worldwide, the increase in oil price has become a heavy burden to car users. Further, cars consume excessive oil because of incomplete combustion of fuel within the engine. Moreover, cars emit fumes which contain a large amount of toxic gas, thereby causing air pollution.

In addition to energy conservation and emission reduction of crude oil, other energy resources, such as liquefied petroleum gas (LPG), natural gas (NG), coolants, etc., also result in consumption of energy when passing through a piping. Therefore, a boiler, a stove, a furnace, an air conditioner, natural gas vehicle, natural gas piping, crude oil piping, and other kinds of apparatuses and piping must also be subjected to energy conservation and emission reduction measures.

### SUMMARY OF THE INVENTION

Therefore, the object of the present invention is to provide an article that can promote conservation of energy and that can minimize emission of toxic gas.

According to this invention, an energy-harvesting article comprises a multi-layered body that includes two textile units, a first adhesive layer, and two second adhesive layers. Each textile unit has a thin metal sheet, and a leather sheet covering the thin metal sheet and including a non-woven fabric substrate and a leather coating layer. The first adhesive layer is disposed between and interconnects the thin metal sheets of the textile units. Each second adhesive layer is disposed between and interconnects the thin metal sheet and the leather sheet of a respective textile unit. Each of the non-woven fabric substrate and the leather coating layer includes a catalytic composition composed of peppermint oil, lemon oil, rhubarb powder, rice flour, ethylenediaminetetraacetric acid (EDTA), polyoxyethylene sorbitan monooleate, glyceryl monostearate, polyethylene glycol 100 stearate (PEG-100 stearate), aromatizer, and dyes. The catalytic composition is mixed with water and then is stored at room temperature to obtain an organic hydrate.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a sectional view of an energy-harvesting article according to the preferred embodiment of the present invention being configured as a wrapping bond;

FIG. 2 is a perspective view of the preferred embodiment in a state of use;

FIG. 3 is a schematic view of the preferred embodiment in another state of use; and

FIG. 4 is another schematic view of the preferred embodiment in yet another state of use.

### DETAILED DESCRIPTION OF THE PREFERRED EMBODIMENT

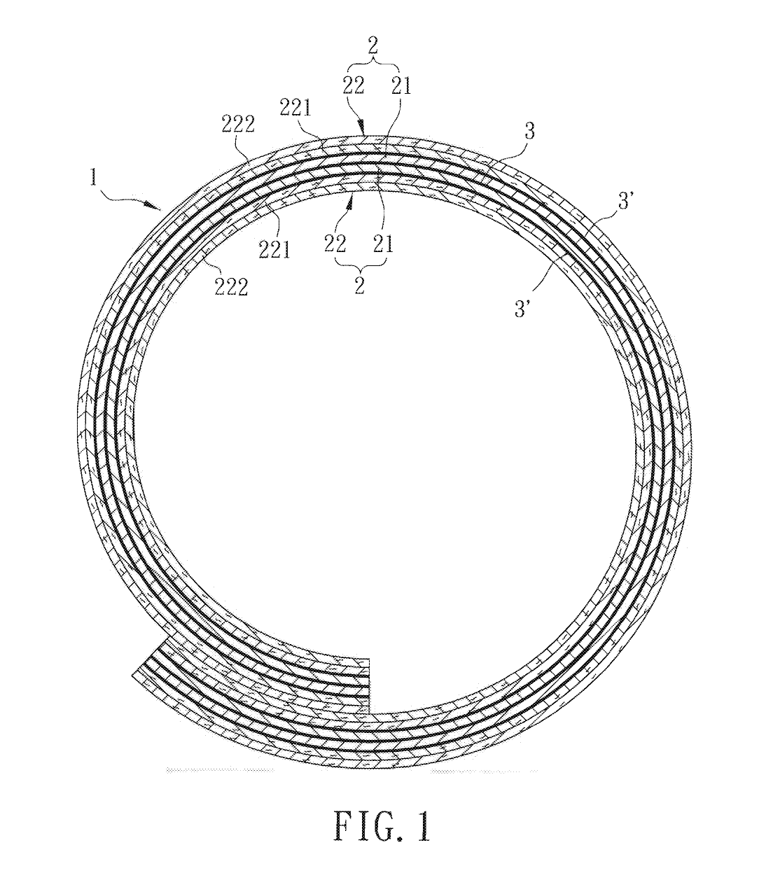

Referring to FIG. 1, an energy-harvesting article 1 according to the preferred embodiment of the present invention is shown to comprise a multi-layered body that includes two textile units 2, a first adhesive layer 3, and two second adhesive layers 3′.

Each textile unit 2 includes a thin metal sheet 21 which can be made of aluminum, stainless steel, or copper; and a leather sheet 22 covering an outer surface of the thin metal sheet 21. The leather sheet 22 includes a non-woven fabric substrate 221 and a leather coating layer 222 that are adhered together to form as one composite body. During making of the leather sheet 22, the non-woven fabric substrate 221 and the leather coating layer 222 are first soaked in a catalytic solution (not shown), so that each of the non-woven fabric substrate 221 and the leather coating layer 222 includes 1˜1.5% by weight of a catalytic composition.

The first adhesive layer 3 is disposed between and interconnects the thin metal sheets 21 of the textile units 2.

Each of the second adhesive layers 3′ is disposed between and interconnects the thin metal sheet 21 and the leather sheet 22 of a respective textile unit 2.

The catalytic composition includes 4% by weight of peppermint oil; 4.5% by weight of lemon oil; 95.5% by weight of rhubarb powder; 30% by weight of rice flour; 2.4% by weight of ethylenediaminetetraacetric acid (EDTA); 1.9% by weight of polyoxyethylene sorbitan monooleate (Tween 80); 3.5% by weight of glyceryl monostearate (Arlacel 165) and polyethylene glycol 100 stearate (PEG-100 stearate); 7% by weight of aromatizer (such as glycerine, jasmine oil, and peanut hull); and 0.7% by weight of dyes. The catalytic composition is mixed with a suitable amount of water and then is stored at room temperature to obtain an organic hydrate. The rice flour and the rhubarb powder serve as a base, and the lemon oil serves to suppress oxidation.

A method for making the catalytic composition includes the following steps:

A. Rice grain is heated at a temperature range of 60˜80° C. for 3˜5 minutes. However, charring and caking of the rice grain should be prevented. The purpose of heating the rice grain is to remove water content therein and at the same time to activate molecules therein. The heated rice grain is then pulverized, put into a mixer, and is mixed with water at a weight ratio of 1:30. The gross weight of the rice grain and the water is about 20˜25 kilos. Prior to agitation of the mixer, 2 kilos of crystal or mineral powder are added into the mixture of rice grain and water. The mixer is operated for 9 days to obtain around 20˜25 kilos of mixed liquid. The mixed liquid is then filtered to remove the precipitate therefrom. Afterwards, 4% by weight of lemon oil is added to the filtered mixed liquid, and is continuously mixed for at least 24 hours, thereby obtaining rice liquid.

B. A commonly sold rhubarb powder is mixed with water at a weight ratio of 1:1 and is agitated to form viscous matter. The viscous matter is then placed in ice storage that is set to a temperature of −4° C. for at least 72 hours so as to catalyze reaction within the viscous matter.

C. Tap water is purified to obtain purified water. In this embodiment, the purification method employs soaking of maifanite. The rice liquid obtained in step A and the viscous matter obtained in step B are mixed together in equal amounts. 4.5% by weight of lemon oil and a trace (about 0.001% by weight) of sodium benzoate are added to the mixture of rice liquid and viscous matter in the mixer for at least 8 hours, and the gross weight thereof is controlled at about 20˜25 kilos.

D. About 20 kilos of the product obtained in step C is added with at least an equal amount of the purified water and the self-made electrolytic ionized water in a vertical mixer. The mixture is mixed for at least 72 hours, after which 2.4% by weight of EDTA, 1.4% by weight of polyoxyethylene sorbitan monooleate (Tween 80), and 3.5% by weight of glyceryl monostearate (Arlacel 165) and PEG-100 stearate are added to the mixture. The mixture is divided into several batches. Each batch of the mixture is added with a suitable amount of rice liquid and viscous matter, and is agitated in the mixer for at least 24 hours. Afterwards, the obtained product is ground using a water grinder to form slurry, and the slurry is sealed, packed, and stored for at least half a year. Finally, precipitate is removed therefrom.

E. The aforesaid precipitate is cooked using a high temperature distiller to form a viscous mixture, after which water is added and mixed with the mixture. Simultaneously, 7% by weight of aromatizer (in this embodiment, jasmine oil, peanut hull, egg hull, and almond extract are used) and 0.7% by weight of direct dyes are added to the mixture to thereby obtain a green watery mixture.

F. The green watery mixture is put in separate bottles and left undisturbed. After at least over 20 years of maturity period, the green watery mixture is diluted with water or deep ocean water. The dilution ratio is 1:1000, thereby obtaining the catalytic composition.

Therefore, the catalytic composition in the energy-harvesting article 1 of the present invention can be added in any manufacturing process to serve as a liquid or powdery form additive, a catalyst, or a coating agent, or can be made first into polymer and then into non-woven shape. That is, the components of the energy-harvesting article 1 including the non-woven fabric substrate 221 and the leather coating layer 222 can be added with the catalytic composition, so that the article produced therefrom has activation and catalytic functions, the product in contact and attached therewith has a function or biochemical quality of a liquid-solid phase catalyst or carrier, and can be diluted in accordance with different industry requirements to form a thin film composite having multiple phase photocatalytic functions.

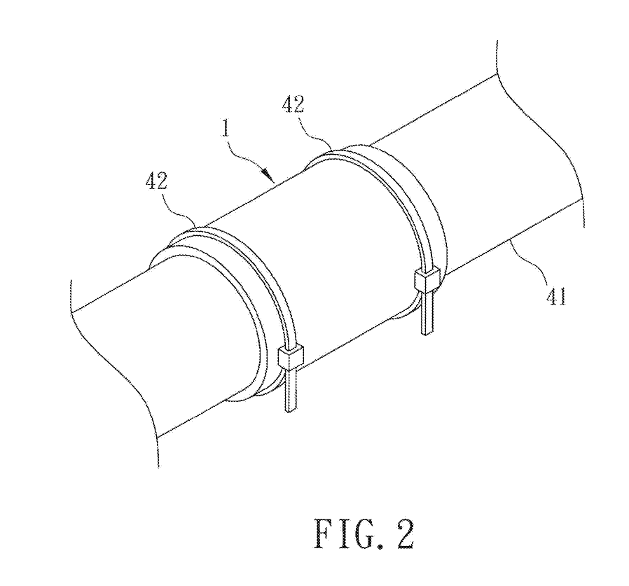

Referring to FIG. 2, in this embodiment, the multi-layered body of the energy-harvesting article 1 is configured as a wrapping bond that is adapted to be tied to pipes 41 by using two binding strips 42. The pipes 91 may be coolant pipes, water pipes, gas pipes, or electric wires.

The experiments described below were performed to prove that the energy-harvesting article 1 of the present invention has the aforesaid effects.

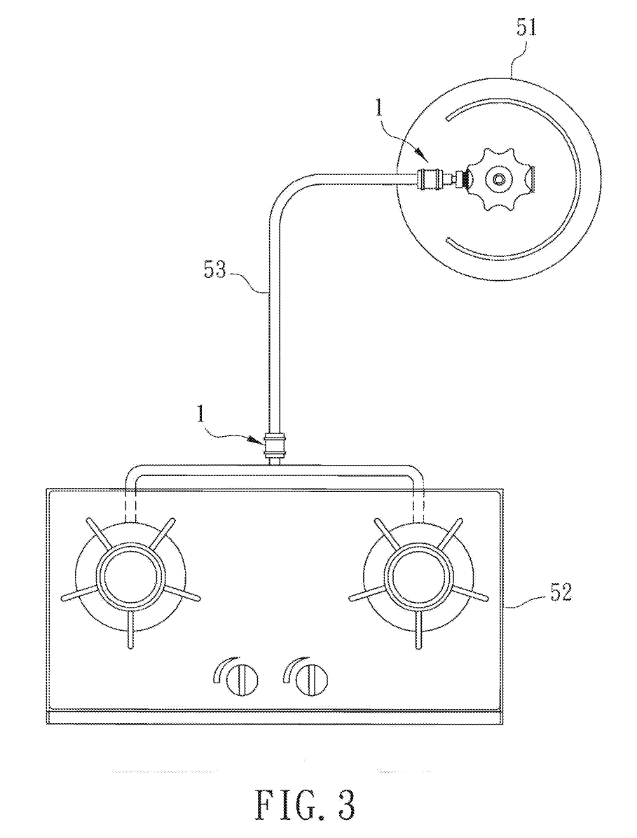

Referring to FIG. 3, this application involved gas from a gas tank 51 being directed into a gas stove 52 through a gas pipe 53. The gas pipe 53 had two opposite ends connected respectively to the gas tank 51 and the gas stove 52 and bound respectively with the energy-harvesting articles 1 of the present invention. In this experiment, flame temperatures between the gas stove 52 connected to the gas pipe 53 that is bound with the energy-harvesting articles 1 and the gas stove 52 connected to the gas pipe 53 that is without the energy-harvesting articles 1 were compared. As shown in Chart 1, the flame temperatures of the gas stove 52 were measured. This measurement was conducted with the assumption that the amount of gas flowing through the gas pipe 53 is fixed.

CHART 1

| Test No. | Flame Temperature of | Flame Temperature of |
|---|---|---|
| (each test | Gas Stove | Gas Stove |
| having a | (Gas pipe without the | (Gas pipe bound with |
| 2-minute | energy-harvesting | the energy-harvesting |
| interval) | articles) | articles) |
| 1 | 85° C. | 94° C. |
| 2 | 88° C. | 86° C. |
| 3 | 92° C. | 90° C. |
| 4 | 92° C. | 90° C. |
| 5 | 79° C. | 93° C. |
| 6 | 87° C. | 91° C. |
| 7 | 80° C. | 87° C. |
| 8 | 90° C. | 91° C. |
| 9 | 94° C. | 91° C. |
| 10 | 86° C. | 89° C. |
| Average | 87.3° C. | 90.2° C. |

It is apparent from Chart 1 that the average flame temperature of the gas stove 52 having the gas pipe 53 bound with the energy-harvesting articles 1 was higher than that without the energy-harvesting articles 1 by about 3° C. Hence, the energy-harvesting articles 1 of the present invention when bound to the gas pipe 53 can enhance the flame temperature of the gas stove 52, thereby enhancing energy efficiency.

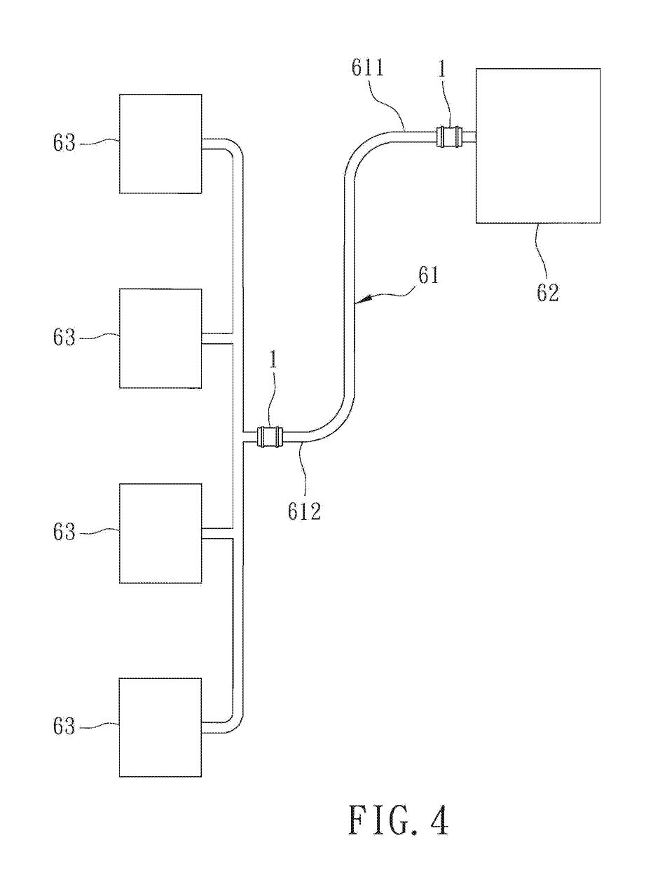

FIG. 4 illustrates an oil pipe 61 of a vehicle having one end 611 connected to an oil tank 62 and another opposite end 612 connected to four engine cylinders 63. The energy-harvesting articles 1 of the present invention were bound respectively to the ends 611, 612 of the oil pipe 61. As shown in Chart 2, the energy-harvesting articles 1 of the present invention can also enhance fuel efficiency in automobiles. Further, the emission of exhaust fumes and heat and noise generated by a running motor can also be reduced.

| | CHART 2 | | | | | | |
|---|---|---|---|---|---|---|---|
| | Type of Vehicle | | | | | | |
| | Nissan | Nissan | Ford | Toyota | Ford | Ford | Ford |
| | 2200 cc | 1600 cc | 1600 cc | 2000 cc | 2000 cc | 1324 cc | 1300 cc |
| Energy | 6.4% | 10.2% | 9.5% | 8.1% | 5.6% | 13% | 10.6% |
| Saving | | | | | | | |
| Rate | | | | | | | |

As to an LPG (liquefied petroleum gas) car installed with the energy-harvesting article 1 of the present invention, through a measuring and analysis test of a specific gravity of carbon, the emission of exhaust fumes is reduced, as shown in Chart 3.

CHART 3

| | CO | NMHC |
|---|---|---|
| | (Carbon | (Non-Methane |
| | Monoxide) | Hydrocarbon) |
| LPG car (without the | 3.58 g/km | 0.078 g/km |
| energy-harvesting article of the | | |
| present invention) | | |
| LPG car (with the energy-harvesting | 2.42 g/km | 0.070 g/km |
| article of the present invention) | | |
| Reduction Percentage | −32.4% | −10.3% |

Further, the energy-harvesting article 1 may also be bound to an exhaust pipe (not shown) of a vehicle. An experiment revealed that an exhaust pipe without the energy-harvesting article 1 emits carbon monoxide at a rate of 3.58 g/km, and an exhaust pipe bound with the energy-harvesting article 1 emits carbon monoxide at a rate of 2.92 g/km. Hence, the vehicle having the exhaust pipe bound with the energy-harvesting article 1 can reduce emission of carbon monoxide, thereby minimizing discharge of toxic substances.

Therefore, by wrapping up the pipes with the energy-harvesting article 1 of the present invention, the material of the energy-harvesting article 1 is considered as self-assembled monclayers, and the energy-harvesting article 1 is harvesting energy from the environment and resonant tunneling through inner portions of the pipes sc as to activate flowing medium inside the pipes, thereby improving energy efficiency.

In a refrigeration system, for example, when the energy-harvesting article 1 of the present invention was tied to the refrigerant pipes of the York 3T A/C and the refrigerant pipes of the True Freezer, the ampere change of current for each system was observed and was illustrated in Chart 4. It is found that the energy efficiency of the York 3T A/C was increased by about 1.5%, and the energy efficiency of the True Freezer was increased by about 5%. That is, the present invention can enhance the energy efficiency of coolant to about 1.5˜5%.

CHART 4

| | York 3T A/C | True Freezer |
|---|---|---|
| | AMPs | AMPs |
| Unwrapped (without the | 8.27 | 5.45 |
| energy-harvesting article of | | |
| the present invention) | | |
| Wrapped (with the | 8.41 | 5.72 |
| energy-harvesting article of | | |
| the present invention) | | |

It is worth mentioning that by wrapping the energy-harvesting article 1 of the present invention to a tubular body, such as an oil pipe, a gas pipe, and a water pipe inside a vehicle, or to an industrial tubular body for conveying flow of a fluidic substance and a pipeline of a machine body, the fluidic substance flowing inside the tubular body can be activated, thereby achieving the purpose of conserving consumption of energy.

Similarly, when the energy-harvesting article 1 is bound to an air conditioner piping or a natural gas piping, the coolant or natural gas in the piping thereof can be activated to prevent consumption of energy.

Aside from Charts 1˜4, the energy-harvesting article 1 of the present invention was also installed and tested on a Ducane Gas Furnace FITS-ALL 80™. The test results are shown in Chart 5. Test 1 is the situation in which the Ducane Gas Furnace is not installed with the energy-harvesting article 1. Each of the Tests 2˜5 is the situation in which the Ducane Gas Furnace is installed with the energy-harvesting article 1. The testing time was 8˜10 mins.

CHART 5

| | Test 1 | | Test 2 | | Test 3 | | Test 4 | | Test 5 | |
|---|---|---|---|---|---|---|---|---|---|---|
| Outdoor | 90° | F. | 65° | F. | 65° | F. | 62° | F. | 75° | F. |
| Temperature | | | | | | | | | | |
| Initial Room | 90° | F. | 88° | F. | 86° | F. | 89° | F. | 90° | F. |
| Temperature | | | | | | | | | | |
| Burner Head | 297° | F. | 296° | F. | 299° | F. | 310° | F. | 299° | F. |
| Temperature (3 mins | | | | | | | | | | |
| after the | | | | | | | | | | |
| test started) | | | | | | | | | | |
| Fuel Temperature | 181° | F. | 186° | F. | 213° | F. | 195° | F. | 192° | F. |
| (3 mins after the | | | | | | | | | | |
| test started) | | | | | | | | | | |
| Heat Sink | 261° | F. | 289° | F. | 301° | F. | 309° | F. | 293° | F. |
| Temperature (3 mins | | | | | | | | | | |
| after the | | | | | | | | | | |
| test started) | | | | | | | | | | |
| Noise Level of | 93.7 | dB | 92.1 | dB | 92.0 | dB | 91.5 | dB | 91.0 | dB |
| Pump (3 mins | | | | | | | | | | |
| after the test | | | | | | | | | | |
| started) | | | | | | | | | | |
| Current during | 6.85 | A | 6.10 | A | 6.03 | A | 6.35 | A | 6.39 | A |
| test (3 mins | | | | | | | | | | |
| after the test | | | | | | | | | | |
| started) | | | | | | | | | | |
| Final Room | 115° | F. | 113° | F. | 111° | F. | 111° | F. | 115° | F. |
| Temperature | | | | | | | | | | |
| Amount of natural | 12.1 | cu. ft. | 11.4 | cu. ft. | 13.8 | cu. ft. | 15.2 | cu. ft. | 14.8 | cu. ft. |
| gas used | | | | | | | | | | |

From the average test results of Tests 2˜5, in comparison with that of Test 1, burner head temperature was increased by 2.5%, fuel temperature was increased by 6.9%, heat sink temperature was increased by 15.3%, noise level of pump was reduced by 2.6%, and AC current used by the furnace was reduced by 7.01%. Hence, combustion efficiency, noise reduction, and consumption of energy have been improved.

The energy-harvesting article 1 of the present invention was also installed and tested on a Boiler and a Micro Turbine of Pasadena City College. The gas bills obtained are illustrated in Chart 6.

CHART 6

| | Oct | Nov | Dec | Jan |
|---|---|---|---|---|
| 2008-2009 | $34045.03 | $37532.26 | $48691.20 | $61979.85 |
| (Without energy- | | | | |
| harvesting | | | | |
| article of the | | | | |
| present | | | | |
| invention) | | | | |
| 2009-2010 | $23431.34 | $33274.48 | $52715.46 | $46004.08 |
| (With energy- | | | | |
| harvesting | | | | |
| article of the | | | | |
| present | | | | |
| invention) | | | | |

The total gas bill from October 2008-January 2009 was 182248.34. The total gas bill from October 2009-January 2010 was 155425.36. The gas bill from October 2009-January 2010, in comparison with that from October 2008-January 2009, was lowered by 14.72%. Hence, it is apparent that when the Boiler and the Micro Turbine were installed with the energy-harvesting article 1 of the present invention, consumption of gas can be minimized.

The energy-harvesting article 1 of the present invention was also installed and tested on a ten-million-watt natural gas power generator. The test results are shown in Chart 7. It is apparent that gas usage and power generating efficiency of the natural gas power generator installed with the energy-harvesting article 1 on February 2010 are enhanced as compared to that of the natural gas power generator that is not installed with the energy-harvesting article 1 on February 2009.

CHART 7

| | Physical Energy | KWh |
|---|---|---|
| | (MMBTU) | Generated |
| February 2009 | 158,801 | 1,307,000 |
| (Without energy-harvesting | | |
| article of the present | | |
| invention) | | |
| February 2010 | 580,900 | 4,684,000 |
| (With energy-harvesting | | |
| article of the present | | |
| invention) | | |

When the energy-harvesting article 1 of the present invention was installed on Caltech Power & Exhaust System, after 20 and 30 days, the reduction in the amount of the following gases was obtained, and was shown in Chart 8.

CHART 8

| | NH3 Flow | NOx | CO | Power | Fuel Flow |
|---|---|---|---|---|---|
| | PPH | PPM | PPM | KWh | PPH |
| Unwrapped (without | 4.28 | 1.96 | 0.62 | 10078 | 5325.00 |
| the energy-harvesting | | | | | |
| article of the present | | | | | |
| invention) | | | | | |
| 1/1-1/5/2010 | | | | | |
| Wrapped (with the | 3.72 | 1.90 | 1.04 | 10057 | 5295.00 |
| energy-harvesting | | | | | |
| article of the present | | | | | |
| invention) 2/9-2/28 | | | | | |
| (20 Days) | | | | | |
| Wrapped (with the | 3.62 | 1.74 | 0.94 | 10013 | 5301.00 |
| energy-harvesting | | | | | |
| article of the present | | | | | |
| invention) | | | | | |
| 3/1-3/30 (30 Days) | | | | | |

From Chart 8, it is apparent that because the thermal efficiency of power consumption is decreased by 20˜70 kwh, the amount of ammonia (NH₃) and the amount of nitrogen oxide (NOx) were decreased by about 10˜20%, and the amount of carbon monoxide (CO) was increased by about 50%. This is mainly because the catalyst of the present invention can convert CO₂ in exhaust fumes into CO, so that the amount of CO is increased. Further, the ammonia (NH₃) and nitrogen oxide (NOx) can be decomposed and, discharged. Thus, energy savings by about 20˜70 kwh can be realized. The reason for this is that the energy reduction of 20˜70 kwh is regarded as the conversion energy of ammonia (NH₃), nitrogen oxide (NOx), and CO₂, so that discharge of ammonia (NH₃) and nitrogen oxide (NOx) is minimized, and CO₂ is converted into and discharged as CO.

In summary, the present invention obtains energy from the surrounding environment to save electricity, and following the reduction of electricity, the amount of carbon dioxide (CO₂), sulfur dioxide (SO₂), and nitrogen oxide (NOx) are also reduced, thereby minimizing greenhouse gas emission and resolving current critical problem of carbon taxes.

From the aforementioned description, it is realized that the problem of heat and mass transfer of micro-scale nano energy devices is an important subject of research, especially that related to the method of measuring varied micro-scale thermal parameters and carrying out instrumentation, referred to as weave future device for energy storage. An important index of the present invention is the resonant tunneling phenomenon. This phenomenon exists in the complicated environment, and contains coupling process of varied energy forms, but can ignore osmotic pressure, PH value, ion concentration, metabolism substrata, and keeping balance formula. The resonant tunneling phenomenon is very different from physical and chemical phenomena, and affects application of energy sources of cold, hot, electric, etc. Hence, the energy-harvesting article 1 of the present invention can activate flowing medium inside the pipes because of resonant tunneling through the inner portions of the pipes, so that energy efficiency can be improved, thereby achieving energy conservation and reduction of carbon discharge effects.

Especially, the energy-harvesting article 1 of the present invention, whether used for residential and industrial conservation of energy (e.g., on gas pipes, exhaust pipes, air conditioning pipes, or natural gas pipes), or for transportation conservation of energy (e.g., on vehicle fuel exhaust pipes or vehicle natural gas pipes), or for energy disposal and delivery e.g., on natural gas pipes or crude oil pipes), can bring about great results in energy conservation and emission reduction.

The present invention can also be applied to fields such as:
(A) Boiler/cogeneration energy enhancement.
(B) Generation of alternative energy in the field of feasible global renewable energy in the future.
(C) Natural gas energy enhancement/Large projects of LNG hydrate pipes.
(D) New generation energy development applications-LNG energy increase performance/Waste minimization of diesel vehicles and purification of petrol vehicles/New projects of saving energy for gas vehicles.
(E) Purification of special gas of semi-conductor/promote process yield of wafer and decrease pipe corrosion to save energy and lower organic waste pollution of exhaust volatile organic compounds (VOCs).
(F) Piping of air conditioning unit, power generating unit, and different powered vehicles (such as gasoline cars, diesel cars, LNG cars, gas-electric hybrid vehicles) so as to reduce the load of air conditioners, air pollution, and discharge of carbon.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. An energy-harvesting article comprising a multi-layered body that includes
two textile units each having a thin metal sheet, and a leather sheet covering said thin metal sheet, said leather sheet including a non-woven fabric substrate and a leather coating layer;
a first adhesive layer disposed between and interconnecting said thin metal sheets of said textile units; and
two second adhesive layers each disposed between and interconnecting said thin metal sheet and said leather sheet of a respective said textile unit;
each of said non-woven fabric substrate and said leather coating layer including a catalytic composition composed of peppermint oil, lemon oil, rhubarb powder, rice flour, ethylenediaminetetra-acetric acid (EDTA), polyoxyethylene sorbitan monooleate, glyceryl monostearate, polyethylene glycol 100 stearate (PEG-100 stearate), aromatizer, and dyes;
said catalytic composition being mixed with water and then being stored at room temperature to obtain an organic hydrate.

2. The energy-harvesting article of claim 1, wherein said catalytic composition includes 4% by weight of peppermint oil; 4.5% by weight of lemon oil; 45.5% by weight of rhubarb powder; 30% by weight of rice flour; 2.4% by weight of ethylenediaminetetraacetric acid (EDTA); 1.4% by weight of polyoxyethylene sorbitan monooleate; 3.5% by weight of glyceryl monostearate and polyethylene glycol 100 stearate (PEG-100 stearate); 7% by weight of aromatizer; 0.7% by weight of dyes; and a suitable amount of water.

3. The energy-harvesting article of claim 1, wherein said multi-layered body is configured as a wrapping bond adapted to be tied to pipes which may be coolant pipes, water pipes, gas pipes, or electric wires so as to activate flowing medium inside the pipes.

4. The energy-harvesting article of claim 2, wherein said non-woven fabric substrate of said leather sheet of each said textile unit includes 11.5% by weight of said catalytic composition.

5. The energy-harvesting article of claim 4, wherein said leather coating layer of said leather sheet of each said textile unit includes 1˜1.5% by weight of said catalytic composition.

6. The energy-harvesting article of claim 1, wherein said thin metal sheet of each said textile unit is made of aluminum, stainless steel, or copper.
